(19) United States
(12) Patent Application Publication
(10) Pub. No.: US 2011/0195215 A1
(43) Pub. Date: Aug. 11, 2011

(54) SEMI-AROMATIC COPOLYAMIDE AND PROCESS FOR PREPARING SAME

(75) Inventors: Thierry Briffaud, Caorches Saint Nicolas (FR); Philippe Blondel, Bernay (FR); Thierry Lefebvre, Beaumont Le Roger (FR)

(73) Assignee: ARKEMA FRANCE, COLOMBES (FR)

(21) Appl. No.: 12/996,417

(22) PCT Filed: Aug. 6, 2009
(86) PCT No.: PCT/FR2009/051567

§ 371 Date: Mar. 22, 2011

(30) Foreign Application Priority Data
Aug. 8, 2008 (FR) 0855502
Oct. 3, 2008 (FR) 0856706

(51) Int. Cl. C08L 77/06; C08G 69/14; B32B 1/08

(52) U.S. Cl. 428/36.9; 528/288; 524/607; 525/184

(57) ABSTRACT

The invention relates to a copolyamide comprising at least two units corresponding to the following general formula:

A/10,T
in which:
A is chosen from a unit obtained from an amino acid, a unit obtained from a lactam and a unit corresponding to the formula (Ca diamine).(Cb (cyclo)aliphatic diacid), with a representing the number of carbon atoms of the diamine and b representing the number of carbon atoms of the diacid, a and b each being between 4 and 36;
10,T denotes a unit obtained from the polycondensation of 1,10-decanediamine and terephthalic acid,
characterized in that it has a polydispersity index, denoted by Ip, of less than or equal to 3.5, measured by gel permeation chromatography.

The invention also relates to the process for preparing said copolyamide, a composition comprising this polyamide and also the use of this polyamide and of such a composition.

One subject of the present invention is a semi-aromatic copolyamide, its preparation process, and also its uses, especially in the manufacture of various articles, for instance common consumer goods such as electrical, electronic or motor vehicle equipment, surgical equipment, packaging or else sport articles.

The invention also relates to a composition comprising such a copolyamide and also to the uses of this composition, especially in the manufacture of all or some of the articles which have just been listed above.

### PRIOR ART AND TECHNICAL PROBLEM

In the motor vehicle industry for example, the polyamides 12 and 11 are widely used due to their remarkable mechanical properties, their ease of use and their resistance to ageing. However, above an operating temperature of 160° C., their thermomechanical strength is inadequate. The copolyamides of formula 11/10,T, which result from the polycondensation of 11-aminoundecanoic acid, 1,10-decanediamine and terephthalic acid make it possible to replace the polyamides 12 and 11, while resulting in an improved thermomechanical strength, and while retaining their ease of conversion and their flexibility.

Document WO 93/14145 describes the synthesis of polyamides derived from dodecanediamine and terephthalic acid, which have a high melting temperature and good dimensional stability.

Document EP 1 505 099 describes semi-aromatic polyamides, such as the copolyamide of formula 11/10,T, which have advantageous properties. It has been shown that these polyamides are flexible and have a low water uptake. They also have good elongation properties and a high thermomechanical strength.

However, these polyamides can still be improved, especially in terms of crystallinity and crystallization kinetics with a view to improving the temperature resistance of the copolyamide, or else improving their impact strength properties.

This problem is mainly faced for copolyamides of formula 11/10,T and also for copolyamides of X,Y/10,T type.

Thus, there is a real need to find semi-aromatic copolyamides that have improved properties, especially improved mechanical properties, while retaining the advantages described above in terms of high-temperature resistance, and also the preparation processes thereof.

### BRIEF DESCRIPTION OF THE INVENTION

Surprisingly, the Applicant has found that these needs are met with a copolyamide comprising at least two different units corresponding to the following general formula:

A/10,T

in which:
A is chosen from a unit obtained from an amino acid, a unit obtained from a lactam and a unit corresponding to the formula (Ca diamine).(Cb (cyclo)aliphatic diacid), with a representing the number of carbon atoms of the diamine and b representing the number of carbon atoms of the diacid, a and b each being between 4 and 36;
10,T denotes a unit obtained from the polycondensation of 1,10-decanediamine and terephthalic acid, characterized in that it has a polydispersity index, denoted by Ip, of less than or equal to 3.5, measured by gel permeation chromatography.

Indeed, the copolyamides of formula 11/10,T as described in document EP 1 505 099 have a polydispersity index, denoted by Ip, and measured by steric exclusion chromatography or gel permeation chromatography, which is high. Generally it is around 5 to 6.

The polydispersity index gives a first idea of the distribution of the molecular weights of the various macromolecules within the polymer. For a perfect polymer, in which all the macromolecules would be linear, would have the same length and consequently would have the same molecular weight, the polydispersity index Ip would be equal to 1. For a polyamide obtained by polycondensation from, amongst other monomers, diamines and dicarboxylic acids, the expected polydispersity index is 2.0.

A polydispersity index above 2 may be due to the presence of branchings on the main chain of the polymer. In the case of copolyamides, the branchings may appear on the nitrogen atom of the amide functional group. Thus, they may be quantified by NMR (Nuclear Magnetic Resonance) by comparing the amount of tertiary (branched) aromatic amide with the amount of secondary (linear) aromatic amide.

The synthesis of a copolyamide with a high polydispersity index of formula 11/10,T as described in document EP 1 505 099 has proved to be difficult to control. Indeed, the viscosity of this polyamide has a tendency to increase rapidly, leading to poor drainage of the synthesis reactors.

Thus, the Applicant has found that by selecting the copolyamide as a function of its polydispersity index and especially by choosing it to be less than or equal to 3.5, the copolyamide had improved properties.

For example, it has been observed that when the copolyamide of formula 11/10,T had a high polydispersity index, the crystallization kinetics were lower, the crystallinity lower and the copolyamide was more fragile, that is to say had a poor impact strength, and a lower elongation at brake compared to a copolyamide having a polydispersity index of less than or equal to 3.5. Furthermore, when the polydispersity index is very high, the copolyamide exhibits gelation and a loss of the thermoplastic properties.

Another subject of the present invention is the process for preparing said copolyamide using hypophosphorous acid or one of the salts thereof in the polycondensation step.

Specifically, it has been observed that the addition of hypophosphorous acid or of one of the salts thereof during the polycondensation of the comonomers made it possible to reduce the polydispersity index of the final copolyamide, compared to known copolyamides, to a value of less than or equal to 3.5, and more particularly to a value of between 2.0 and 3.0.

### DETAILED DESCRIPTION OF THE INVENTION

Other features, aspects, subjects and advantages of the present invention will appear more clearly on reading the description and examples that follow.

According to a first aspect of the invention, the invention relates to a copolyamide comprising at least two different units of the following formula:

A/10,T

in which:
A is chosen from a unit obtained from an amino acid, a unit obtained from a lactam and a unit corresponding to the formula (Ca diamine).(Cb (cyclo)aliphatic diacid), with a representing the number of carbons of the diamine and b representing the number of carbons of the diacid, a and b each being between 4 and 36;
10,T denotes a unit obtained from the polycondensation of 1,10-decanediamine and terephthalic acid,
said copolyamide having a polydispersity index, denoted by Ip, of less than or equal to 3.5, measured by gel permeation chromatography.

Preferably, the polydispersity index of said copolyamide is between 2.0 and 3.0.

This index is measured in a conventional manner known to a person skilled in the art by steric exclusion chromatography or gel permeation chromatography as indicated above. Preferably, the polydispersity index of the copolyamides according to the invention is measured by gel permeation chromatography. More particularly, it is measured in a suitable solvent for the copolyamide, for instance a fluorinated solvent such as for example hexafluoroisopropanol, at a temperature between 20° C. and 50° C., preferably at 40° C.

It is specified that the expression “between” used in the preceding paragraphs but also in the remainder of the present description should be understood as including each of the limits mentioned.

Regarding more specifically the meaning of the unit A, when A represents an amino acid, it may be chosen from 9-aminononanoic acid (A=9), 10-aminodecanoic acid (A=10), 10-aminoundecanoic acid (A=11), 12-aminododecanoic acid (A=12) and 11-aminoundecanoic acid (A=11) and also derivatives thereof, especially N-heptyl-11-aminoundecanoic acid.

Instead of an amino acid, a mixture of two, three, or more amino acids could also be envisioned. However, the copolyamides formed would then comprise three, four or more units respectively.

When A represents a lactam, it may be chosen from pyrrolidinone, 2-piperidinone, enantholactam, caprylolactam, perlargolactam, decanolactam, undecanolactam and lauryllactam (A=12).

Preferably, A denotes a unit obtained from a monomer chosen from 10-aminoundecanoic acid (denoted by 11), 11-aminoundecanoic acid (noted by 11), 12-aminododecanoic acid (denoted by 12) and lauryllactam (denoted by L12).

Among the combinations that can be envisioned, the following copolyamides are of particularly pronounced interest: they are copolyamides corresponding to one of the formulae chosen from 11/10,T and 12/10,T.

When the unit A is a unit corresponding to the formula (Ca diamine).(Cb (cyclo)aliphatic diacid), the (Ca diamine) unit is chosen from linear or branched aliphatic diamines, cycloaliphatic diamines and alkylaromatic diamines.

When the diamine is aliphatic and linear, of formula H₂N—(CH₂)ₐ—NH₂, the (Ca diamine) monomer is preferably chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22) and the diamines obtained from fatty acids.

When the diamine is aliphatic and branched, it may comprise one or more methyl or ethyl substituents on the main chain. For example, the (Ca diamine) monomer may advantageously be chosen from 2,2,4-trimethyl-1,6-hexanediamine, 2,4,4-trimethyl-1,6-hexanediamine, 1,3-diaminopentane, 2-methyl-1,5-pentanediamine, 2-methyl-1,8-octanediamine.

When the (Ca diamine) monomer is cycloaliphatic, it is chosen from bis(3,5-dialkyl-4-aminocyclohexyl)methane, bis(3,5-dialkyl-4-aminocyclohexyl)ethane, bis(3,5-dialkyl-4-aminocyclohexyl)propane bis(3,5-dialkyl-4-aminocyclohexyl)butane, bis(3-methyl-4-aminocyclohexyl)methane (BMACM or MACM), p-bis(aminocyclohexyl)methane (PACM) and isopropylidenedi(cyclohexylamine) (PACP). It may also comprise the following carbon-based backbones: norbornyl methane, cyclohexylmethane, dicyclohexylpropane, di(methylcyclohexyl), di(methylcyclohexyl)propane. A non-exhaustive list of these cycloaliphatic diamines is given in the publication “Cycloaliphatic Amines” (Encyclopedia of Chemical Technology, Kirk-Othmer, 4th Edition (1992), pp. 386-405).

When the (Ca diamine) monomer is alkylaromatic, it is chosen from 1,3-xylylenediamine and 1,4-xylylenediamine.

The expression “(Cb (cyclo)aliphatic diacid) monomer” is understood to mean an aliphatic monomer, which may be linear or branched, or a cycloaliphatic monomer.

When the (Cb diacid) monomer is aliphatic and linear, it is chosen from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18), octadecenedioic acid (b=18), eicosanedioic acid (b=20), docosanedioic acid (b=22) and fatty acid dimers containing 36 carbons.

The fatty acid dimers mentioned above are dimerized fatty acids obtained by oligomerization or polymerization of unsaturated monobasic fatty acids with a long hydrocarbon-based chain (such an linoleic acid and oleic acid), as described, in particular, in document EP 0 471 566.

When the diacid is cycloaliphatic, it may comprise the following carbon-based backbones: norbornyl methane, cyclohexylmethane, dicyclohexylmethane, dicyclohexylpropane, di(methylcyclohexyl), di(methylcyclohexyl)propane.

Among all the possible combinations for the copolyamides A/10,T, in which A is a (Ca diamine).(Cb (cyclo)aliphatic diacid) unit, the copolyamides corresponding to one of the formulae chosen from 6,10/10,T, 6,12/10,T, 10,10/10,T, 10,12/10,T, 12,12/10,T will be retained in particular.

Preferably, the molar proportions of 1,10-decanediamine (denoted by 10) and of terephthalic acid (denoted by T) are preferably stoichiometric.

Preferably, the molar ratio of A unit(s) to the 10,T unit(s) is between 0.1 and 1, and preferably between 0.2 and 0.7.

According to a second aspect of the invention, the copolyamide is a copolymer that contains only two different units, namely an A unit and the 10,T unit.

According to a third aspect of the invention, the copolyamide also comprises at least three different units and corresponds to the following formula:

A/10,T/Z

in which:
the units A and 10,T have the same meaning as defined above and
Z is chosen from a unit obtained from an amino acid, a unit obtained from a lactam and a unit corresponding to the formula (Cd diamine).(Ce diacid), with d representing the number of carbon atoms of the diamine and e representing the number of carbon atoms of the diacid, d and e each being between 4 and 36.

When Z represents a unit obtained from an amino acid, it may be chosen from 9-aminononanoic acid (Z=9), 10-aminodecanoic acid (Z=10), 10-aminoundecanoic acid (denoted by 11), 12-aminododecanoic acid (Z=12) and 11-aminoundecanoic acid (Z=11) and also derivatives thereof, especially N-heptyl-11-aminoundecanoic acid.

Instead of an amino acid, a mixture of two, three, or more amino acids could also be envisioned. In this eventuality, the copolyamides formed would then comprise four, five, or more units respectively.

When Z represents a unit obtained from a lactam, it may be chosen from pyrrolidinone, 2-piperidinone, caprolactam (Z=6), enantholactam, caprylolactam, perlargolactam, decanolactam, undecanolactam and lauryllactam (Z=12).

Instead of a lactam, a mixture of two, three, or more lactams or a mixture of one or more amino acids and one or more lactams could also be envisioned. In this eventuality, the copolyamides formed would then comprise four, five or more units respectively.

Among the combinations that can be envisioned, the following copolyamides have a particularly pronounced advantage: these are copolyamides corresponding to one of the formulae chosen from 11/10,T/12, 11/10,T/6 and 12/10,T/6.

Obviously, the particular case where the Z unit, when it is a unit obtained from a lactam or an amino acid, is strictly identical to the A unit is excluded. Indeed, in this particular hypothesis, the copolyamide already envisioned according to the second aspect of the invention is present.

When the Z unit is a unit corresponding to the formula (Cd diamine).(Ce diacid), the (Cd diamine) unit is chosen from linear or branched aliphatic diamines, cycloaliphatic diamines and alkylaromatic diamines.

When the diamine is aliphatic and linear, of formula H₂N—(CH₂)_{d}—NH₂, the (Cd diamine) monomer is preferably chosen from butanediamine (d=4), pentanediamine (d=5), hexanediamine (d=6), heptanediamine (d=7), octanediamine (d=8), nonanediamine (d=9), decanediamine (d=10), undecanediamine (d=11), dodecanediamine (d=12), tridecanediamine (d=13), tetradecanediamine (d=14), hexadecanediamine (d=16), octadecanediamine (d=18), octadecenediamine (d=18), eicosanediamine (d=20), docosanediamine (d=22) and the diamines obtained from fatty acids.

When the diamine is aliphatic and branched, it may comprise one or more methyl or ethyl substituents on the main chain. For example, the (Cd diamine) monomer may advantageously be chosen from 2,2,4-trimethyl-1,6-hexanediamine, 2,4,4-trimethyl-1,6-hexanediamine, 1,3-diaminopentane, 2-methyl-1,5-pentanediamine, 2-methyl-1,8-octanediamine.

When the (Cd diamine) monomer is cycloaliphatic, it is chosen from bis(3,5-dialkyl-4-aminocyclohexyl)methane, bis(3,5-dialkyl-4-aminocyclohexyl)ethane, bis(3,5-dialkyl-4-aminocyclohexyl)propane bis(3,5-dialkyl-4-aminocyclohexyl)butane, bis(3-methyl-4-aminocyclohexyl)methane (BMACM or MACM), p-bis(aminocyclohexyl)methane (PACM) and isopropylidenedi(cyclohexylamine) (PACP). It may also comprise the following carbon-based backbones: norbornyl methane, cyclohexylmethane, dicyclohexylpropane, di(methylcyclohexyl), di(methylcyclohexyl)propane. A non-exhaustive list of these cycloaliphatic diamines is given in the publication “Cycloaliphatic Amines” (Encyclopedia of Chemical Technology, Kirk-Othmer, 4th Edition (1992), pp. 386-405).

When the (Cd diamine) monomer is alkylaromatic, it is chosen from 1,3-xylylenediamine and 1,4-xylylenediamine.

When the Z unit is a unit corresponding to the formula (Cd diamine).(Ce diacid), the (Ce diacid) unit is chosen from linear or branched aliphatic diacids, cycloaliphatic diacids and aromatic diacids.

When the (Ce diacid) monomer is aliphatic and linear, it is chosen from succinic acid (e=4), pentanedioic acid (e=5), adipic acid (e=6), heptanedioic acid (e=7), octanedioic acid (e=8), azelaic acid (e=9), sebacic acid (e=10), undecanedioic acid (e=11), dodecanedioic acid (e=12), brassylic acid (e=13), tetradecanedioic acid (e=14), hexadecanedioic acid (e=16), octadecanedioic acid (e=18), octadecenedioic acid (e=18), eicosanedioic acid (e=20), docosanedioic acid (e=22) and fatty acid dimers containing 36 carbons.

The fatty acid dimers mentioned above are dimerized fatty acids obtained by oligomerization or polymerization of unsaturated monobasic fatty acids with a long hydrocarbon-based chain (such an linoleic acid and oleic acid), as described, in particular, in document EP 0 471 566.

When the diacid is cycloaliphatic, it may comprise the following carbon-based backbones: norbornyl methane, cyclohexylmethane, dicyclohexylmethane, dicyclohexylpropane, di(methylcyclohexyl), di(methylcyclohexyl)propane.

When the diacid is aromatic, it is chosen from terephthalic acid (denoted by T), isophthalic acid (denoted by I) and naphthalenic diacids.

Obviously, the particular case where the (Cd diamine).(Ce diacid) unit is strictly identical to the 10,T unit or to the A unit, when A has the following meaning: (Ca diamine).(Cb (cyclo)aliphatic diacid), is excluded. Indeed, in these particular hypotheses, the copolyamide already envisioned according to the second aspect of the invention is again present.

Among all the possible combinations for the A/10,T/Z copolyamides, in which Z is a (Cd diamine).(Ce diacid) unit, the copolyamides corresponding to one of the formulae chosen from 11/10,T/10,I, 12/10,T/10,I, 10,10/10,T/10,I, 10,6/10,T/10,I and 10,14/10,T/10,I will be retained in particular.

Preferably, when Z denotes a (Cd diamine).(Ce diacid) unit, the (Ce diacid) monomer is aliphatic and linear. In particular, the copolyamides corresponding to one of the formulae chosen from 11/10,T/10,6, and 12/10,T/10,6 will be retained.

In an advantageous version of the invention, the molar ratio of the sum of the A and Z units to the 10,T unit(s) (i.e. (A+Z)/10,T) in the terpolymer is between 0.1 and 1, and preferably between 0.2 and 0.7.

Instead of a (Cd diamine).(Ce diacid) unit, a mixture of two, three or more (Cd diamine).(Ce diacid) units or a mixture of one or more amino acids and/or one or more lactams with one or more (Cd diamine).(Ce diacid) units could also be envisioned. In this eventuality, the copolyamides formed would then comprise four, five or more units respectively.

Another subject of the invention consists of a process for preparing the copolyamide as defined above. This process comprises a step of polycondensation of the comonomers as defined above, namely at least one monomer that results in the A unit, 1,10-decanediamine and terephthalic acid, and optionally one monomer that results in the Z unit, in the presence of hypophosphorous acid or at least one of the salts thereof present in a content between 0.05 and 3% by weight relative to the weight of the sum of the comonomers present in the reaction medium.

The hypophosphorous acid used in the process according to the invention is of formula H₃PO₂. It is also possible to use one of the salts thereof such as sodium hypophosphite, which is sold in its monohydrate form or another of the salts thereof such as the calcium, lithium, magnesium, potassium, vanadium, zinc, manganese, tin, titanium, zirconium, antimony, germanium, aluminium and ammonium salts.

The Applicant has found that hypophosphorous acid or one of the salts thereof used in the process for preparing the copolyamide mentioned above does not have a catalyst function as described in the prior art. Indeed, in the polycondensation reaction according to the invention, it does not act on the rate of the polymerization, unlike phosphoric acid (the polymerization is faster in the absence of hypophosphorous acid or of the salt of the acid).

Hypophosphorous acid or one of the salts thereof does not have an antioxidant action either with respect to the product obtained. Within the context of the polycondensation according to the invention, it has been observed that the hypophosphorous acid or one of the salts thereof, especially the sodium salt, reduced the content of branchings in the main chain, thus acting directly on the polydispersity index.

Preferably, the hypophosphorous acid or one of the salts thereof may be used at a content between 0.05 and 1% by weight relative to the weight of the sum of the comonomers present in the reaction medium.

The weight content of hypophosphorous acid or salts thereof may also be expressed in ppm relative to the sum of the weight of the comonomers present in the reaction medium. This content may be from 500 to 30 000 ppm, preferably from 500 to 10 000 ppm.

The copolyamide according to the invention may comprise monomers originating from resources derived from renewable raw materials, that is to say comprising organic carbon derived from biomass and determined according to the ASTM D6866 standard. These monomers derived from renewable raw materials may be 1,10-decanediamine or, when they are present, in particular 11-aminoundecanoic acid, and the aliphatic and linear diamines and diacids as defined above.

Although, apart from the N-heptyl-11-aminoundecanoic acid, the fatty acid dimers and the cycloaliphatic diamines, the comonomers or starting products envisioned in the present description (amino acids, diamines, diacids) are actually linear, nothing precludes it being envisaged that they could be completely or partly branched, such as 2-methyl-1,5-diaminopentane and partially unsaturated.

It will be noted, in particular, that the C18 dicarboxylic acid may be octadecanedioic acid, which is saturated, or else octadecenedioic acid, which has itself an unsaturated group.

To date there are several processes for preparing such semi-aromatic polyamides.

The embodiments of the process described below are described with the case in which A is an amino acid.

Of course, these embodiments can be transposed to the cases in which A is a lactam or a (Ca diamine).(Cb (cyclo)aliphatic diacid) mixture.

According to a first embodiment of the process according to the present invention, said process comprises the single step of reaction between the amino acid A and the stoichiometric combination of 1,10-decanediamine and terephthalic acid, in the presence of sodium hypophosphite, water and optionally other additives.

According to this first embodiment, the single step is carried out in a temperature range between 200 and 380° C.

This step is carried out under an inert atmosphere and in a pressure range between 0.01 and 50 bar.

This step is made up of several substeps. During the first substep, the reactor is maintained under autogenous steam pressure between 10 and 50 bar at a first temperature hold. During the second substep, the pressure is gradually brought back to atmospheric pressure and the temperature is increased to a second temperature hold. The reaction time is generally 30 minutes to 10 hours, and depends on the temperature. The higher the reaction temperature, the shorter the reaction time. The reaction time must be, in any case, long enough to ensure that the reaction takes place quantitatively.

The temperature holds lie in the range from 200 to 380° C. defined above.

According to a second embodiment of the process according to the present invention, said process comprises two steps. The first step leads to a diacid oligomer being obtained, which will be polycondensed during the second step with 1,10-decanediamine, according to the sequence below:
(i) a first step of reaction between terephthalic acid, with the amino acid A, in the presence of a hypophosphite salt; and
(ii) a second step of reaction of the diacid oligomer thus formed in the preceding step with the 1,10-decanediamine.

In the first reaction step, the diacid oligomer is prepared by condensation of terephthalic acid, with the amino acid A, in the presence of a hypophosphite salt. The reaction takes place in a reactor under an inert atmosphere, at atmospheric pressure and/or under pressure while keeping the reactants, preferably under stirring, at a temperature between 140 and 350° C., and preferably between 200 and 300° C. The reaction generally takes place in one to five hours under atmospheric pressure or under a maximum pressure of 50 bar.

In the second step, added, under atmospheric pressure, to the diacid oligomer formed in the preceding step is the 1,10-decanediamine which is reacted at a temperature between 200 and 350° C., preferably between 240 and 300° C. The reaction generally takes place in an inert atmosphere in 1 to 10 hours under vacuum and/or at atmospheric pressure and/or at a maximum pressure of 50 bar.

In the case where A is a (Ca diamine).(Cb (cyclo)aliphatic diacid) mixture, it is possible to introduce from 10 to 100% by weight of the Ca diamine in the first reaction step (i), the possible remainder of the Ca diamine being introduced with the Cb (cyclo)aliphatic diacid in the second reaction step (ii).

According to a third embodiment of the process according to the present invention, said process comprises two steps:
(i) a first step of reaction of the amino acid A with terephthalic acid, and with 10 to 90% by weight of 1,10-decanediamine, in the presence of a hypophosphite salt; and
(ii) a second step of reaction of the oligomer produced in step (i) with the remainder of the 1,10-decanediamine in one or more stages.

In both steps, the temperature is between 220 and 380° C., preferably between 280 and 330° C. The process is carried out under an inert atmosphere, under a pressure up to 50 bar or at atmospheric pressure, or under vacuum. The reaction generally takes place in 1 to 10 hours.

In the case where A is a (Ca diamine).(Cb (cyclo)aliphatic diacid) mixture, it is possible to introduce from 10 to 100% by weight of the Ca diamine in the first reaction step (i), the optional remainder of the Ca diamine being introduced with the Cb (cyclo)aliphatic diacid in the second reaction step (ii).

According to a fourth embodiment of the process according to the present invention, said process comprises two steps:
(i) a first step of reaction of the amino acid A with terephthalic acid, all of the diamine, in the presence of a hypophosphite salt; an oligomer is obtained by emptying the reactor under steam pressure and crystallization of said oligomer;
(ii) a second step of post-polymerization at atmospheric pressure or under vacuum of the oligomer produced in step (i).

In the first step, the temperature is between 200 and 300° C., preferably between 220 and 260° C. The process is carried out under an inert atmosphere, under a pressure of up to 50 bar. The reaction generally takes place in to 10 hours. A “prepolymer” is removed from the reactor, for which the degree of progress of the reaction is between 0.4 and 0.99.

In the second step, the temperature is between 220 and 380° C., preferably between 280 and 330° C. The process is carried out under an inert atmosphere, under atmospheric pressure or under vacuum. The reaction generally takes place in a few seconds and up to a few tens of hours depending on the polymerization temperature.

This prepolymer may be taken up directly, or with an intermediate storage period in solid form (granule or powder for example), in order to carry out the end of the polycondensation. This operation is referred to as: rise in viscosity. This rise in viscosity can be carried out in a reactor of extruder type under atmospheric pressure or under vacuum. This rise in viscosity may also, in the case of crystalline or semicrystalline copolyamides, be carried out in the solid phase, at a temperature between the glass transition temperature (T_{g}) and the melting temperature. Conventionally, this is a temperature of around 100° C. above the T_{g}. The heating may be provided by a heat-transfer gas or fluid, such as nitrogen, steam or inert liquids such as certain hydrocarbons.

The processes according to the present invention may be carried out in any reactor conventionally used in polymerization, such as anchor agitator or ribbon mixer reactors. However, when the process comprises a step (ii) as defined above, it may also be carried out in a horizontal reactor or finisher, more commonly referred to by a person skilled in the art as a “finisher”. These finishers may be equipped with a vacuum device, a device for introducing reactant (addition of diamine), which may or may not be staggered, and may operate over a wide temperature range.

It is possible to add, to these copolyamides, at the end of the process or during the second step, when the process comprises two steps, besides the remainder of the diamine, customary additives for polyamides, as defined below.

Preferably, the additives for the copolyamide prepared according to the present invention are present in an amount of up to 90%, preferably from 1 to 60%, by weight relative to the weight of the composition.

The invention also relates to the copolyamide capable of being obtained by the processes defined above.

The invention also relates to a composition comprising at least one copolyamide according to the invention.

A composition according to the invention may also comprise at least one second polymer.

Advantageously, this second polymer may be chosen from a semicrystalline polyamide, an amorphous polyamide, a semicrystalline copolyamide, an amorphous copolyamide, a polyetheramide, a polyesteramide, an aromatic polyester, an arylamide and mixtures thereof.

This second polymer may also be chosen from starch, which may be modified and/or formulated, cellulose or derivatives thereof such as cellulose acetate or cellulose ethers, polylactic acid, polygycolic acid and polyhydroxyalkanoates.

In particular, this second polymer may be one or more functional or non-functional, crosslinked or non-crosslinked polyolefins.

As regards the crosslinked polyolefins, this phase can originate from the reaction (i) of two polyolefins having groups which react with one another, (ii) of maleated polyolefins with a monomeric, oligomeric or polymeric diamino molecule, or (iii) of one (or more) unsaturated polyolefin(s) bearing an unsaturated group and which can be crosslinked, for example, by the peroxide route.

Among the reaction routes (i), (ii) and (iii) mentioned, it is the reaction of two polyolefins (i) that is favoured, the corresponding crosslinked phase originating, for example, from the reaction:
of a product (A) comprising an unsaturated epoxide,
of a product (B) comprising an unsaturated carboxylic acid anhydride,
optionally of a product (C) comprising an unsaturated carboxylic acid or of an α,ω-aminocarboxylic acid.

### Product A

Mention may be made, as examples of product (A), of those comprising ethylene and an unsaturated epoxide.

According to a first form of the invention, (A) is either a polyolefin grafted by an unsaturated epoxide or an ethylene/unsaturated epoxide copolymer.
As regards the polyolefin grafted by an unsaturated epoxide, the term “polyolefin” is understood to mean polymers comprising olefin units, such as, for example, ethylene, propylene, 1-butene or all other α-olefin units. Mention may be made, by way of example, of:
polyethylenes, such as LDPE, HDPE, LLDPE or VLDPE, polypropylene, ethylene/propylene copolymers, EPRs (ethylene-propylene rubber) or else metallocene PEs (copolymers obtained by single-site catalysis),
styrene/ethylene-butylene/styrene (SEBS) block copolymers, styrene/butadiene/styrene (SBS) block copolymers, styrene/isoprene/styrene (SIS) block copolymers, styrene/ethylene-propylene/styrene block copolymers or ethylene-propylene-diene monomer (EPDM) terpolymers;
copolymers of ethylene with at least one product chosen from salts or esters of unsaturated carboxylic acids or vinyl esters of saturated carboxylic acids.

Advantageously, the polyolefin is chosen from LLDPE, VLDPE, polypropylene, ethylene/vinyl acetate copolymers or ethylene/alkyl (meth)acrylate copolymers. The density may advantageously be between 0.86 and 0.965 and the melt flow index (MFI) may be between 0.3 and 40 (in g/10 min at 190° C./2.16 kg).

As regards the ethylene/unsaturated epoxide copolymers, mention may be made, for example, of ethylene/alkyl (meth)acrylate/unsaturated epoxide copolymers or ethylene/saturated carboxylic acid vinyl ester/unsaturated epoxide copolymers. The amount of epoxide may be up to 15% by weight of the copolymer and the amount of ethylene at least 50% by weight.

Advantageously, (A) is an ethylene/alkyl (meth)acrylate/unsaturated epoxide copolymer. Preferably, the alkyl (meth)acrylate is such that the alkyl has 2 to 10 carbon atoms.

The MFI (melt flow index) of (A) may, for example, be between 0.1 and 50 (g/10 min at 190° C./2.16 kg).

Examples of alkyl acrylates and methacrylates that may be used are in particular methyl methacrylate, ethyl acrylate, n-butyl acrylate, isobutyl acrylate and 2-ethylhexyl acrylate. Examples of unsaturated epoxides that may be used are in particular:
aliphatic glycidyl esters and ethers, such as allyl glycidyl ether, vinyl glycidyl ether, glycidyl maleate, glycidyl itaconate, glycidyl acrylate and glycidyl methacrylate, and
alicyclic glycidyl esters and ethers, such as 2-cyclohexen-1-yl glycidyl ether, diglycidyl cyclohexene-4,5-carboxylate, glycidyl cyclohexene-4-carboxylate, glycidyl 5-norbornene-2-methyl-2-carboxylate and diglycidyl endo-cis-bicyclo[2.2.1]hept-5-ene-2,3-dicarboxylate.

According to another form of the invention, the product (A) is a product having two epoxide functional groups, such as, for example, bisphenol A diglycidyl ether (BADGE).

### Product B

Mention may be made, as examples of product (B), of those comprising ethylene and an unsaturated carboxylic acid anhydride.

(B) is either an ethylene/unsaturated carboxylic acid anhydride copolymer or a polyolefin grafted by an unsaturated carboxylic acid anhydride.

The polyolefin may be chosen from the polyolefins mentioned above which have to be grafted by an unsaturated epoxide.

Examples of unsaturated dicarboxylic acid anhydrides that may be used as constituents of (B) are in particular maleic anhydride, itaconic anhydride, citraconic anhydride and tetrahydrophthalic anhydride.

Mention may be made, as examples, of ethylene/alkyl (meth)acrylate/unsaturated carboxylic acid anhydride copolymers and ethylene/saturated carboxylic acid vinyl ester/unsaturated carboxylic acid anhydride copolymers.

The amount of unsaturated carboxylic anhydride may be up to 15% by weight of the copolymer and the amount of ethylene at least 50% by weight.

Advantageously, (B) is an ethylene/alkyl (meth)acrylate/unsaturated carboxylic anhydride copolymer. Preferably, the alkyl (meth)acrylate is such that the alkyl has 2 to 10 carbon atoms.

The alkyl (meth)acrylate may be chosen from those mentioned above.

The MFI of (B) may, for example, be between 0.1 and 50 (g/10 min at 190° C./2.16 kg).

According to another form of the invention, (B) can be chosen from aliphatic, alicyclic or aromatic polycarboxylic acids or their partial or complete anhydrides.

Mention may be made, as examples of aliphatic acids, of succinic acid, glutaric acid, pimelic acid, azelaic acid, sebacic acid, adipic acid, dodecanedicarboxylic acid, octadecanedicarboxylic acid, dodecenesuccinic acid and butanetetracarboxylic acid.

Mention may be made, as examples of alicyclic acids, of cyclopentanedicarboxylic acid, cyclopentane-tricarboxylic acid, cyclopentanetetracarboxylic acid, cyclohexanedicarboxylic acid, hexanetricarboxylic acid, methylcyclopentanedicarboxylic acid, tetrahydrophthalic acid, endo-methylenetetrahydrophthalic acid and methyl-endo-methylenetetrahydrophthalic acid.

Mention may be made, as examples of aromatic acids, of phthalic acid, isophthalic acid, terephthalic acid, trimellitic acid, trimesic acid or pyromellitic acid.

Mention may be made, as examples of anhydrides, of the partial or complete anhydrides of the above acids.

Use is advantageously made of adipic acid.

It would not be outside the scope of the invention if a portion of the copolymer (B) were to be replaced with an ethylene/acrylic acid copolymer or an ethylene/maleic anhydride copolymer, the maleic anhydride having been completely or partially hydrolysed. These copolymers may also comprise an alkyl (meth)acrylate. This portion may represent up to 30% of (B).

### Product C

With regard to the product (C) comprising an unsaturated carboxylic acid, mention may be made, as examples, of the products (B) completely or partly hydrolysed. (C) is, for example, an ethylene/unsaturated carboxylic acid copolymer and advantageously an ethylene/(meth)acrylic acid copolymer.

Mention may also be made of ethylene/alkyl (meth)acrylate/acrylic acid copolymers.

These copolymers have an MFI of between 0.1 and 50 (g/10 min at 190° C./2.16 kg).

The amount of acid may be up to 10% by weight and preferably 0.5 to 5%. The amount of (meth)acrylate is from 5 to 40% by weight.

(C) may also be chosen from α,ω-aminocarboxylic acids, such as, for example, NH₂—(CH₂)₅COOH, NH₂—(CH₂)₁₀COOH and NH₂—(CH₂)₁₁—COOH and preferably aminoundecanoic acid.

The proportion of (A) and (B) necessary to form the crosslinked phase is determined according to the usual rules of the art by the number of reactive functional groups present in (A) and in (B).

For example, in the crosslinked phases comprising (C) chosen from α,ω-aminocarboxylic acids, if (A) is a copolymer of ethylene, of an alkyl (meth)acrylate and of an unsaturated epoxide and (B) is a copolymer of ethylene, of an alkyl (meth)acrylate and of an unsaturated carboxylic acid anhydride, the proportions are such that the ratio of the anhydride functional groups to the epoxy functional groups is in the region of 1.

The amount of α,ω-aminocarboxylic acid is then from 0.1 to 3% and preferably 0.5 to 1.5% of (A) and (B).

As regards (C) comprising an unsaturated carboxylic acid, that is to say (C) being chosen, for example, from ethylene/alkyl (meth)acrylate/acrylic acid copolymers, the amount of (C) and (B) may be chosen so that the number of acid functional groups and of anhydride functional groups is at least equal to the number of epoxide functional groups and, advantageously, products (B) and (C) are used such that (C) represents 20 to 80% by weight of (B) and preferably 20 to 50%.

It would not be outside the scope of the invention if a catalyst were added.

These catalysts are generally used for the reactions between the epoxy groups and the anhydride groups.

Mention may in particular be made, among the compounds capable of accelerating the reaction between the epoxy functional group present in (A) and the anhydride or acid functional group present in (B), of:
tertiary amines, such as dimethyllaurylamine, dimethylstearylamine, N-butylmorpholine, N,N-dimethylcyclohexylamine, benzyldimethylamine, pyridine, 4-(dimethylamino)pyridine, 1-methylimidazole, tetramethylethylhydrazine, N,N-dimethylpiperazine, N,N,N′,N′-tetramethyl-1,6-hexanediamine or a mixture of tertiary amines having from 16 to 18 carbons and known under the name of dimethyl tallowamine;
1,4-diazabicyclo[2.2.2]octane (DABCO);
tertiary phosphines, such as triphenylphosphine;
zinc alkyldithiocarbamates.

The amount of these catalysts is advantageously from 0.1 to 3% and preferably 0.5 to 1% of (A)+(B)+(C).

Preferably, the crosslinked polyolefins are present in the composition generally in a content of 5 to 50%, preferably of around 30% by weight relative to the total weight of the composition.

As regards the noncrosslinked polyolefins, mention may be made of the polyolefins described in the preceding section and intended to be grafted by reactive groups. Mention may also be made of the products (A) or (B) or (C) from the preceding section but used alone in order not to crosslink. Mention may be made, by way of example, of the EPR or EPDM elastomers, it being possible for these elastomers to be grafted in order to make it easier to render them compatible with the copolyamide. Mention may also be made of acrylic elastomers, for example those of the NBR, HNBR or X—NBR type.

The composition according to the invention may additionally include at least one additive, as mentioned previously within the context of the copolyamide preparation process.

This additive may especially be chosen from fibres, dyes, light stabilizers, especially UV stabilizers, and/or heat stabilizers, plasticizers, mould-release agents, fire retardants, standard fillers such as talc, glass fibres, pigments, metal oxides, metals, impact modifiers, surfactants, optical brighteners, antioxidants, natural waxes and mixtures thereof.

The fillers envisaged within the context of the present invention include conventional mineral fillers, such as the fillers chosen from the group, given in a non-limiting manner, comprising: silica, carbon black, carbon nanotubes, expanded graphite, titanium oxide, glass beads, kaolin, magnesia, and scoria. The filler used more generally is formed from glass fibres, the size of which is advantageously between 0.20 and 25 mm. It is possible to include therein a coupling agent in order to improve the adhesion of the fibres to the polyamide, such as silanes or titanates, which are known to a person skilled in the art. Anionic fillers may also be used, such as graphite or aramid fibres (entirely aromatic polyamides).

Preferably, the glass fibres are present in the composition generally in a content of 10 to 50%, preferably of around 30% by weight relative to the total weight of the composition.

The copolyamide according to the invention or else the composition according to the invention may be used to form a powder or else granules. The copolyamide according to the invention or else the composition according to the invention may also be used to form a structure for subsequent uses or conversions.

This structure may be a single-layer structure when it is formed only from the copolyamide or only from the composition according to the invention.

This structure may also be a multilayer structure, when it comprises at least two layers and when at least one of the various layers forming the structure is formed from the copolyamide or from the composition according to the invention.

The powder, the granules or else the structure, whether it is a single-layer or multilayer structure, may be present in the form of fibres (for example in order to form a woven or non-woven fabric), a film, a pipe, filaments, a moulded article, a three-dimensional article obtained by technology for powder agglomeration by melting or sintering brought about by radiation, a hollow body or an injection-moulded part.

For example, the films and sheets may be used in fields as varied as electronics or decoration.

The copolyamide according to the invention or the composition according to the invention may advantageously be envisioned for producing all or part of components of electric and electronic goods, such as encapsulated solenoids, pumps, telephone, computer, multimedia systems, motor vehicle equipment such as pipes, pipe connectors, pumps, under-bonnet injection-moulded parts, surgical equipment, packaging or else sport or leisure articles, such as bicycle equipment (saddle, pedals).

More particularly, these components of motor vehicle equipment, when they are in the form of pipes and/or connectors, may in particular be used in air intake devices, cooling (for example via air, coolant, etc.) devices and fuel or fluid (such as oil, water, etc.) transport or transfer devices. Such components may obviously be made antistatic or conductive, by prior addition of suitable amounts of conductive fillers (such as carbon black, carbon fibres, carbon nanotubes, etc.) to the copolyamide or the composition according to the invention.

The copolyamide according to the invention or the composition according to the invention may also be envisioned for producing all or part of components of equipment (especially pipes, hoses, connectors, pumps, etc.) for transporting or transferring gas, oil and compounds thereof, in particular intended for use in the offshore field.

As examples, when the copolyamide according to the invention or the composition according to the invention is in the form of powder, the latter may be used in coatings, and especially coatings with improved thermal resistance intended to cover metallic parts used in the transport of fluids (water, chemicals, oil and gas, etc.), used in the motor vehicle field, for example under the bonnet, or used in the industrial field, especially engine parts. The powders according to the invention may also be used as additives and/or fillers having improved heat resistance in paints requiring a high baking temperature, that is to say above 180° C. These powders may be used in anti-corrosion compositions, in anti-abrasion compositions, and/or in paints. The powders according to the invention may also be used in technologies for powder agglomeration by melting or sintering brought about by radiation, such as for example laser sintering or infrared (IR) sintering, for manufacturing articles. The said powders may also be used as additives for paper, or else in electrophoresis gels, or as spacers in multilayer composites, especially between the layers of multilayer materials. The uses thereof in the packaging industry, toy industry, textile industry, motor vehicle industry, electronics industry, cosmetics industry, pharmaceutical industry and fragrance industry can be envisioned.

As examples, the granules comprising the copolyamide according to the invention or the composition according to the invention are used for manufacturing, especially by extrusion, filaments, pipes, films and/or moulded articles.

The invention also relates to the use of hypophosphorous acid or at least one of the salts thereof in the polycondensation step of a copolyamide as defined above in a content between 0.05 and 3.00% by weight relative to the weight of the sum of the comonomers present in the reaction medium, for controlling the polydispersity index, that is to say for obtaining a polydispersity index of less than or equal to 3.5.

Preferably, sodium hypophosphite (NaH₂PO₂) is used.

Other objectives and advantages of the present invention will appear on reading the following examples, which are given without any implied limitation.

### EXAMPLES

### 1

### Examples of the Synthesis of a Copolyamide According to the Invention

Introduced into a 1 litre autoclave reactor are 111.82 g (0.65 mol) of decanediamine, 104.57 g (0.63 mol) of terephthalic acid, 87.00 g (0.43 mol) of 11-aminoundecanoic acid, 6.00 g (0.021 mol) of stearic acid, 0.40 g (0.0022 mol) of sodium hypophosphite at a concentration of 60% in water and 30 g of water. After removal of gaseous oxygen by inerting with nitrogen, the reactor is brought to a material temperature of 220° C., under a pressure of 20 bar. The temperature is gradually increased over 1 hour up to 260° C. while keeping this pressure constant. The pressure is then gradually brought, via expansion, to atmospheric pressure over 1 hour, whilst the material temperature is increased to 280° C. The polymerization is continued at this temperature for 30 minutes. The polymer is extracted from the reactor, cooled in water and granulated.

A polymer having an inherent viscosity equal to 1.14 is obtained.

NMR indicates an aromatic tertiary amide/secondary amide molar ratio of 0.92% and the polydispersity index obtained by GPC is 2.75.

### 2

### Comparative Tests

A—Comparison of Polyamides as a Function of the Amount of Sodium Hypophosphite Present in the Reaction Medium

The polymers A to G are prepared according to the process described above.

This process is adapted as a function of the nature of the reactants and of the molar proportions thereof, as indicated in the table below.
Aromatic tertiary amide/aromatic secondary amide molar ratio, denoted by NMR T/S Amide in the table, is obtained by NMR.
The polydispersity index is obtained by GPC (gel permeation chromatography) according to the following experimental conditions:
Apparatus: Waters Alliance 2695 instrument
Solvent: hexafluoroisopropanol stabilized with 0.05M potassium trifluoroacetate (KTFA)
Flow rate: 1 ml/minute
Temperature of the columns: 40° C.
Set of two columns from PSS: 1000 Å PFG and 100 Å PFG
Concentration of the samples: 1 g/L (dissolution at ambient temperature over 24 h)
Injection volume: 100 μl
Refractometer detection at 40° C.
UV detection at 228 nm
PMMA calibration from 1 900 000 to 402 g·mol⁻¹.

The polydispersity index is determined as being equal to the ratio between the weight-average molecular weight and the number-average molecular weight, M_{w}/Mₙ. The accuracy of the measurement is given to within 5%.
The inherent viscosity (denoted by η) is measured in m-cresol, at 20° C., using a type 538-23 IIC Schott Micro-Ubbelohde tube.
The melting temperature, denoted by Tf and the crystallization temperature, denoted by Tc are determined by differential scanning calorimetry (DSC), using a Netzsch 204F1 (Intracooler cooling) DSC according to the following program:
first heat: from −50 to 250° C. at 20° C./min.
cooling: from 250 to −50° C. at 20° C./min.

| | 10, T | 11 | Stearic | | | | | | |
|---|---|---|---|---|---|---|---|---|---|
| | (in | (in | acid | NaH₂PO₂ | | T/S | | Tc | Tf |
| | mol) | mol) | (in %) | (in %) | Ip | Amide | η | (° C.) | (° C.) |
| A (invention) | 1 | 0.7 | — | 0.08 | 2.519 | 0.65 | 1.1 | 209.8 | 262.8 |
| B | 1 | 0.7 | — | — | 7 | 1.72 | 1.59 | 176.1 | 257.5 |
| (comparative) | | | | | | | | | |
| C (invention) | 1 | 0.7 | 0.50 | 0.24 | 2.878 | 0.99 | 1.16 | 208.3 | 261.1 |
| D (invention) | 1 | 0.7 | 0.50 | 0.08 | 2.605 | 0.95 | 1.08 | 208 | 261.2 |
| E | 1 | 0.7 | 0.50 | — | 6.005 | 2.13 | 1.2 | 203 | 260 |
| (comparative) | | | | | | | | | |
| F (invention) | 1 | 0.7 | 2.50 | 0.08 | 3.048 | 0.77 | 1.17 | 208.1 | 261.5 |
| G | 1 | 0.7 | 2.50 | 0.02 | 4.165 | 1.27 | 1.29 | 205.1 | 253.9 |
| (comparative) | | | | | | | | | |

B—Comparison of Materials Based on Copolyamides as a Function of the Presence of Sodium Hypophosphite Present in the Reaction Medium

The polymers D and E defined in the table above were mixed in a BUSS mixer with around 30% of glass fibres and 1.4% of an Iodine 201 antioxidant additive from Ciba. Bars of these formulations, denoted D′ and E′ respectively, were injection-moulded according to the ISO 179 standard. A portion of these bars was kept for experiment 1 and the other portion was kept for experiment 2.

Experiment 1: Initial Impact

The bars were conditioned at −40° C. for at least two hours. They were then tested in an ISO 179-1eU Charpy pendulum impact test with a pendulum of 7.5 Joules. The energy absorbed by the bars was measured, it is expressed in kJ/m².

Experiment 2: Impact after Ageing

The bars were placed in 1.5 lire autoclaves (in an amount of 16 bars per autoclave) containing 1.4 litres of E85 petrol (constituted of 85% of Rectapur ethanol and 15% of L fluid, an unleaded 95 petrol). These autoclaves were placed in ventilated ovens at 140° C. for 168 hours. After cooling, these bars were immediately conditioned at −40° C. for at least two hours.

They were then tested in an ISO 179-1eU Charpy pendulum impact test with a pendulum of 7.5 Joules, in an identical manner to experiment 1. The energy absorbed by the bars was measured, it is expressed in kJ/m².

The bar produced from formulation E′ (with the polyamide E synthesized without sodium hypophosphite) and that underwent ageing exhibited cracks after the residence time in the E85 at 140° C. Consequently, the experiment was not carried out on this sample.

The results are described in the table below:

| | D′ | E′ |
|---|---|---|
| | (invention) | (comparative) |
| % of glass fibres in the material | 30 | 30 |
| Ip of the formulation | 2.75 | 5.7 |
| Inherent viscosity of the formulation | 1.04 | 1.1 |
| Experiment 1: initial impact (kJ/m²) | 83 | 55.5 |
| Experiment 2: impact after ageing (kJ/m²) | 75.3 | Cracks |

1. Copolyamide comprising at least two units corresponding to the following general formula:
A/10,T
in which:
A is chosen from a unit obtained from an amino acid, a unit obtained from a lactam and a unit corresponding to the formula (Ca diamine).(Cb (cyclo)aliphatic diacid), with a representing the number of carbon atoms of the diamine and b representing the number of carbon atoms of the diacid, a and b each being between 4 and 36;
10,T denotes a unit obtained from the polycondensation of 1,10-decanediamine and terephthalic acid,
characterized in that it has a polydispersity index, denoted by Ip, of less than or equal to 3.5, measured by gel permeation chromatography.

2. Copolyamide according to claim 1, characterized in that it has a polydispersity index between 2 and 3.

3. Copolyamide according to claim 1, characterized in that it comprises at least a third unit and corresponds to the following general formula:
A/10,T/Z
in which:
the units A and 10,T are as defined in claim 1 and
Z is chosen from a unit obtained from an amino acid, a unit obtained from a lactam and a unit corresponding to the formula (Cd diamine).(Ce diacid), with d representing the number of carbon atoms of the diamine and e representing the number of carbon atoms of the diacid, d and e each being between 4 and 36.

4. Copolyamide according to claim 1, characterized in that A denotes a unit obtained from a monomer chosen from 10-aminoundecanoic acid (denoted by 11), 11-aminoundecanoic acid (denoted by 11), 12-aminododecanoic acid (denoted by 12) and lauryllactam (denoted by L12).

5. Copolyamide according to claim 1, characterized in that it is chosen from 11/10,T, 12/10,T, 6,10/10,T, 6,12/10,T, 10,10/10,T, 10,12/10,T, 12,12/10,T, 11/10,T/12, 11/10,T/6 and 12/10,T/6, 11/10,T/10,I, 11/10,T/10,6, 12/10,T/10,1 and 12/10,T/10,6.

6. Process for preparing the copolyamide as defined in claim 1, characterized in that it comprises a polycondensation step of the comonomers: monomer resulting in the unit A as defined in claim 1, 1,10-decanediamine and terephthalic acid, and optionally monomer resulting in the unit Z chosen from a unit obtained from an amino acid, a unit obtained from a lactam and a unit corresponding to the formula (Cd diamine).(Ce diacid), with d representing the number of carbon atoms of the diamine and e representing the number of carbon atoms of the diacid, d and e each being between 4 and 36 in the presence of hypophosphorous acid or at least one of the salts thereof in a content between 0.05 and 3.00% by weight relative to the weight of the sum of the comonomers present in the reaction medium.

7. Process according to claim 6, characterized in that sodium hypophosphite is used.

8. Process according to claim 6, characterized in that the hypophosphorous acid or at least one of the salts thereof is present in a content between 0.05 and 1.00% by weight relative to the weight of the sum of the comonomers present in the reaction medium.

9. Composition comprising at least one copolyamide as defined in claim 1.

10. Composition according to claim 9, characterized in that it comprises at least one additive chosen from fillers, glass fibres, dyes, stabilizers, especially UV stabilizers, plasticizers, impact modifiers, surfactants, pigments, brighteners, antioxidants, natural waxes, polyolefins and mixtures thereof.

11. A powder, granules, a single-layer structure or at least one layer of a multilayer structure, comprising a copolyamide according to claim 1.

12. The powder, the granules, the single-layer structure or else the multilayer structure according to claim 11, in the form of fibres, a film, a pipe, filaments, a moulded article, a three-dimensional article obtained by powder agglomeration, by melting or sintering brought about by radiation, a hollow body or an injection-moulded part.

13. In an additive and/or filler in paint; in coatings, in anti-corrosion compositions, in anti-abrasion compositions; in technologies for powder agglomeration by melting or sintering brought about by radiation in order to manufacture articles; in paper; in electrophoresis gels; in multilayer composites; in packaging; in toys; in textiles; in motor vehicles, in electronics; in cosmetics; in pharmaceuticals or fragrances comprising a copolyamide, the improvement wherein the copolyamide is one of claim 1.

14. In an additive in coatings on metal parts used in the transport of fluids, on motor vehicles, in under hood coatings, or on engine parts, comprising a copolyamide, the improvement wherein the copolyamide is one of claim 1.

15. A process for polycondensation of a copolyamide as defined in claim 1, comprising polycondensing said copolyamide in the presence of hypophosphorous acid in a content between 0.05 and 3.00% by weight relative to the weight of the sum of comonomers present in the reaction medium, in order to obtain a polydispersity index of less than or equal to 3.5.
